(19) United States
(12) Patent Application Publication
(10) Pub. No.: US 2002/0170953 A1
(43) Pub. Date: Nov. 21, 2002

(54) Virtual telephone charge card

(76) Inventor: Anthony B. Claiborne, Bellevue, WA (US)

Correspondence Address: Anthony Claiborne, InfoSpace, Inc., 601 108th Ave. NE, Bellevue, WA, 98004, US

(21) Appl. No.: 09/861,446

(22) Filed: May 18, 2001

(51) Int. Cl. G06F 17/00

(52) U.S. Cl. 235/375

(57) ABSTRACT

A virtual telephone charge card is a portable software application that a caller may invoke to place a charge card telephone call using the caller's computing equipment. Methods of creation of the card comprise utilizing access digits and authorization codes appropriate for the type of charge card access and for the charge card carrier to be used. Invocation of the charge card application by a caller results in the creation of a dialing sequence of digits and pauses which when dialed place a charge card call connecting the caller to the terminating number of the call. Some embodiments create a virtual charge card for dialing only one pre-designated or user specified terminating number for all calls placed with the card, while other embodiments allow the caller to specify the terminating number for a particular call placed with the card.

### BACKGROUND OF THE INVENTION

1. Field of the Invention

This invention relates to telephone charge card services. More particularly, this invention relates to portable software implementations of telephone charge cards and methods of creating them.

2. Description of the Related Art

In both the form of the calling card and of the debit card, the telephone charge card has become a commonplace telephone service technology. In operation with telephone networks, calling cards are a form of charge card where a user with an account uses the account identified on the calling card to pay for services on the telephone network. Using a calling card, a user's telephone calls or other services are charged to the user's calling card account for later payment.

Similarly, a user may purchase a debit card to obtain a certain amount of prepaid credit for purchases and charges. When the debit card is used for a purchase of services, for example to make a toll telephone call, the available credit for subsequent purchases is debited for the amount used for the purchase of the services. Such debit cards are sometimes called “prepaid calling cards.”

In either case, the telephone charge card is typically a plastic or paper substrate containing account identification information in printed and/or magnetically encoded form. In accessing the telephone network, the charge card may be inserted through the slot of a telephone to a card reader, or alternatively, an account number on the card may be entered manually in the telephone, for example, by a touch-tone keypad. In any case, the network billing and switching equipment is informed of the user's account identification from information on the card. Based upon that information, the network billing and switching equipment is able to verify the validity and credit of the user's account, authorizing the rendering of the requested service (typically the placing of a toll-charge telephone call), and billing or debiting the user account appropriately as the requested service is rendered.

Unlike earlier billing technology, which ties charges for most telephone services to the telephone line from which the request for services originates, telephone charge card technology permits a user's account to be used to pay for services requested from any telephone on the Public Shared Telephone Network (PSTN).

The detailed method of telephone charge card usage varies depending upon the provider of the charge card service and the method of access applicable for the charge card service provider from the particular telephone used by the caller.

In one method, Pre-Subscribed Card Service (PCS), when the user has a telephone charge card that can be billed by the long distance carrier for which the originating telephone has been pre-subscribed, the user may simply dial 0 plus terminating number digits to be connected to the carrier's equipment which prompts the user for input of the telephone charge card number.

In another method, Carrier Code Select (CCS), the user dials a carrier access code, typically of the form 1010XXX to direct that the call be carried by the carrier selected by the access code digits. The user then dials 0 plus terminating number digits as in PCS service. This method is not supported for all carriers at all telephone exchanges.

In yet another method, Carrier Access Number Select (CANS), the user dials an actual terminating number for the carrier, typically of the form 1-(NPA)-XXX-XXXX where NPA is either an area code or one of the toll-free codes such as 800 or 877 and XXX-XXXX is the carrier telephone number. Upon being connected by the originating telephone's service to the carrier equipment at the carrier terminating number, the user may be prompted for entry of the charge card information followed by prompting for entry of the desired terminating number (“pre-auth dialing”). In the alternative, upon being connected to the carrier equipment at the carrier terminating number, the user may be prompted for entry of the desired terminating number followed by prompting for the entry of the charge card information (“post-auth dialing”). It should be noted that, when the call to the carrier terminating number is a toll call from the originating exchange, those toll charges will apply to the call and will be sent to the billed party for the originating telephone, in addition to the charges for the call to the desired terminating number which are charged to the telephone charge card.

As set forth above, the methods of use of telephone charge cards vary not only by charge card service provider but also by configuration and exchange of the telephone from which the charge card call originates. This variation, along with the sometimes burdensome number of digits that a user must often enter manually, makes the prior art telephone charge card technology error-prone and often frustrating for the user.

Because a typical telephone debit card may be used by any user possessing the card or user identification information, a user may transfer possession of and authority to use the card to another. The user may be motivated by various reasons to effect such a transfer. For example, in respect to calling cards, an entity issuing a general purpose credit card, such as a bank, may wish to provide its customers with calling cards that may be paid by charging the general purpose credit card account. In respect to debit cards, a user may simply wish to donate the prepaid telephone services to another, as in the case of a parent who gives a child residing at a distance a prepaid calling card for the purpose of enabling toll telephone calls from the child to the parent. Alternatively, a debit card user may wish to transfer the value of the debit card to another as consideration, as in the case where a purchaser of goods or services transfers a prepaid calling card as consideration to the seller, or where a prepaid calling card is offered as a purchasing incentive by a party promoting its goods or services to the public.

In any case, according to the prior art, the transfer of a telephone charge card in general requires either physical transfer of the card or conveying the user account information contained on the card to the receiving party. Where parties are distant from each other, physical transfer of the card is subject to logistical problems and delay. Using the prior art veridical charge card, transfer of the user account information contained on the card to the receiving party may be laborious, subject to transcription error and liable to theft and other security problems.

There are further applications of telephone charge card technology for which the prior art is inadequate. In the case of a “gift” debit card, it may be the case that the donor wishes the donee to use the card for placing calls only to a particular terminating number, as in the case where a parent gives a child a debit card for the child to use to call home. The principal prior art charge card technology, implemented for general-purpose telephone usage, has no such restrictions on terminating number: the debit card typically may be used to call any number. Thereby, the prior art charge card technology frustrates such a donor's intent, that the card be used to call only one terminating number.

Within an appropriate business model, charge card technology can serve profitably to direct traffic to a particular carrier's telephone network. Among carriers who are charge card service providers, there is value in attracting charge card users to a given carrier's network. Prior art does not easily permit a third party to intermediate between carriers and potential charge card users to render the valuable service of providing the consumer the choice of carrier for charge card usage, or, in the alternative, choosing among carriers for a charge card to be issued to a consumer.

What is needed is a charge card technology whereby access and authorization occur largely without user intervention, thereby obviating a common source of dialing error and concomitant user frustration. What is needed further is a charge card technology whereby possession and authorization to use a charge card may be easily but securely transferred over distance. What is needed further is a charge card technology whereby a charge card may be easily created for connecting calls to only one terminating number. What is needed further is a charge card technology enabling third parties to intermediate easily and advantageously between the charge card service provider

### SUMMARY OF THE INVENTION

The present invention discloses a system, method, apparatus and article of manufacture that implements a telephone charge card as a small software application that may be easily generated by an issuer and easily transferred from one party to another, and that, when invoked by a user, directs a user's computing device to place a charge card paid telephone call on behalf of the user.

It is an object of the present invention to provide a software application that utilizes a user's computing device to place a charge card paid telephone call on behalf of the user, with minimum requirements of user interaction.

It is a further object of the present invention to provide a small and portable software application enabling telephone charge card calling that may be easily transferred over distance from one party to another.

It is a further object of the present invention to enable the creation, transfer and use of a telephone charge card configuration that, in some embodiments, permits charge card calling to only one terminating telephone number.

It is a further object of the present invention to permit third parties easily to create and distribute telephone charge cards, thereby enabling various business methods involving the intermediation of such third parties between the charge card service provider and the charge card user.

### BRIEF DESCRIPTION OF THE DRAWINGS

Other objects, advantages, features and characteristics of the present invention, as well as methods, operation and function of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1 is a schematic showing the connectivity of an originating telephone through the Public Shared Telephone Network (PSTN) to a charge card service provider through the PSTN to a terminating telephone.

FIG. 2 is a block diagram illustrating CANS dialing with post-auth digit entry.

FIG. 3 is a block diagram illustrating CANS dialing with pre-auth digit entry.

FIG. 4 is a block diagram illustrating CCS dialing.

FIG. 5 is a simplified flowchart illustrating generation of a charge card software application according to the present invention.

FIG. 6 is a simplified block diagram illustrating creation of a charge card dialing sequence.

FIG. 7 is a flowchart detailing creation of a charge card dialing sequence.

FIG. 8 is a simplified flowchart illustrating invocation and execution of an embodiment wherein the virtual card application prompts the user for the terminating telephone number.

FIG. 9 is a simplified flowchart illustrating invocation and execution of an embodiment wherein the terminating number is pre-programmed in the virtual card application.

### DETAILED DESCRIPTION OF THE PREFERRED EMBODIMENTS

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that changes may be made without departing from the spirit or scope of the invention. To avoid detail not necessary to enable those skilled in the art to practice the invention, the description may omit certain information known to those skilled in the art. The following description is, therefore, not to be taken in a limiting sense.

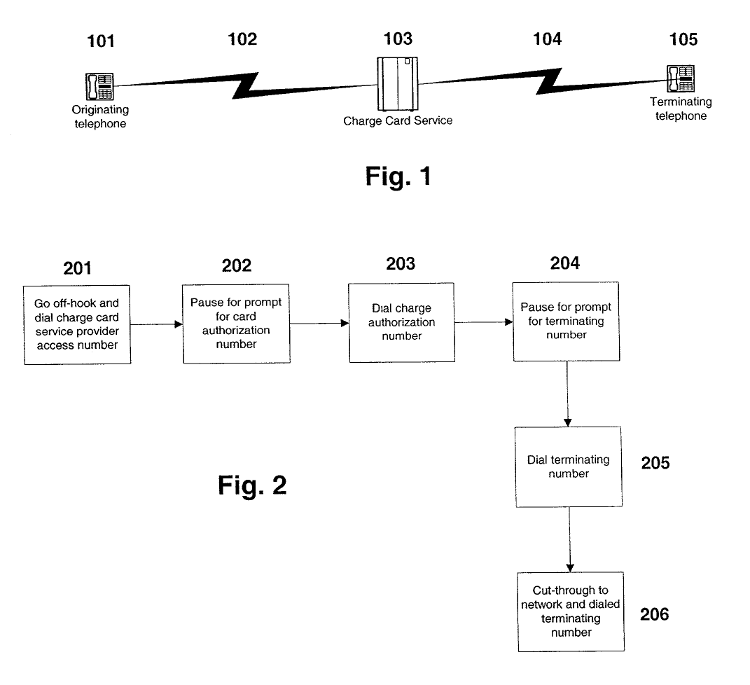

Turning to FIG. 1, illustrated is connectivity of an originating telephone 101 through the Public Shared Telephone Network (PSTN) 102 to the equipment 103 of a charge card service provider through the PSTN 104 to a terminating telephone 105. Details of various ways in which caller on originating telephone 101 completes the connection to terminating telephone 105 are illustrated in FIGS. 2 to 4.

Turning to FIG. 2, illustrated is carrier access number select dialing with post-authorization code digit entry. In this method of charge card service dialing, the caller on originating telephone 101 (FIG. 1) accesses telephone service and dials an access number for the charge card carrier at step 201. In Plain Old Telephone Service (POTS), the caller accesses telephone service by going off-hook and receiving dialtone. For other kinds of telephone service, e.g. Integrated Services Digital Network (ISDN) service, telephone service is accessed differently, such as through a data connection. In any case, the caller's telephone service provider is able to connect the caller through the PSTN 102 (FIG. 1) to the charge card service provider's equipment 103 (FIG. 1) by way of the access number of the charge card service provider. Once connected to the charge card service provider's equipment 103, after a brief delay the caller receives a prompt from the equipment for authorization number entry at step 202. In response, at step 203, the caller dials the authorization number. After validation of the authorization number and another brief delay, at step 204 the caller receives a prompt from the equipment 103 for terminating number entry. At step 205 the caller dials the terminating number and at step 206 the caller is connected or “cut through” through the PSTN 104 (FIG. 1) to the telephone 105 (FIG. 1) at the terminating number.

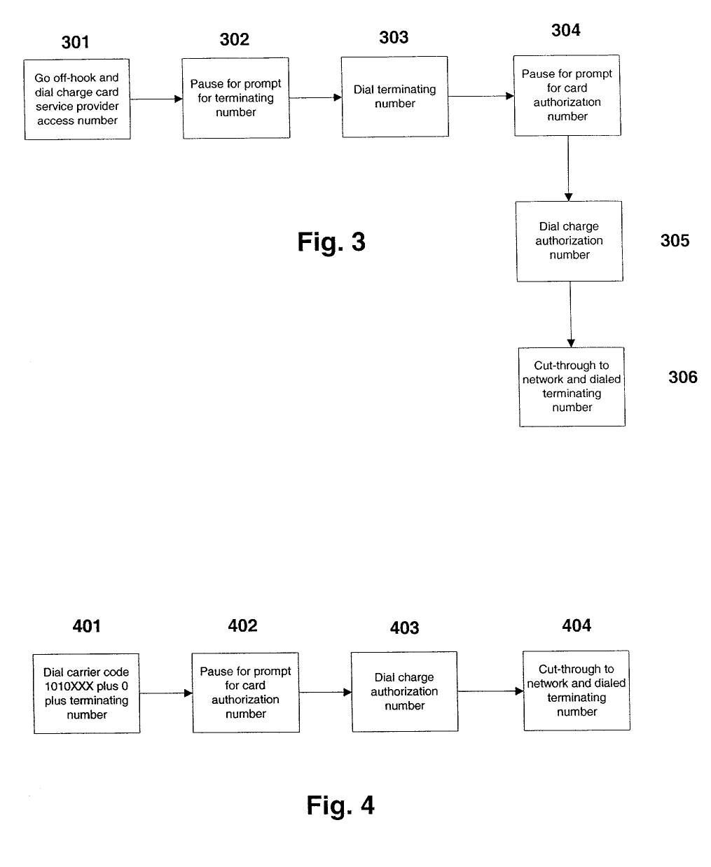

Turning to FIG. 3, illustrated is another form of charge card service dialing, again carrier access number select, but this time with pre-authorization code digit entry. In a manner similar to that illustrated in FIG. 2, the caller accesses telephone service and dials an access number for the charge card carrier's equipment at step 301. Here, however, upon connecting to the charge card carrier's equipment, the caller is first prompted for the terminating number at step 302, which the caller enters at step 303. Next, after a delay, the caller is prompted for entry of the authorization code at step 304. After entry and validation of the authorization code 305, the caller is cut through to the terminating number 306.

Turning to FIG. 4, illustrated is yet another form of charge card service dialing, this time carrier code select charge card service. In this form of dialing, available only for telephone subscribers receiving Feature Group D telephone service, the caller accesses the charge card carrier's equipment by dialing a carrier access code of the form 1010XXX plus the digit “0” plus the terminating telephone number, as show in 401. The sequence of digits “XXX” indicates the particular charge card carrier that will handle this call. This dialing not only connects the caller 101 (FIG. 1) to the charge card carrier's equipment 103 (FIG. 1); it also indicates (by way of the dialed “0”) that the call should receive handling comprising charge card dialing, and it delivers the terminating telephone number to the carrier's equipment 103. In response to receiving the dialed “0” and the terminating telephone number, the charge card carrier's equipment 103 prompts the caller for entry of an authorization number at step 402. The caller dials the authorization number at step 403 and, after validation, is cut through to the terminating number at step 404.

The present invention implements one form or another of charge card service dialing as a software application designed to run on a caller's personal computer system or other personal information device. In a preferred embodiment, the invention comprises generating an application program that can be transmitted to a caller's personal computer. In embodiments where the caller specifies the destination number, when the caller invokes the application program on the caller's personal computer, the caller is prompted to enter the destination number. In other embodiments, the destination number is built into the virtual telephone charge card. In any case, when the application is invoked and the destination number is known to the application, the invention then employs the caller's equipment to place the call to the destination number using one of the forms of charge card service dialing.

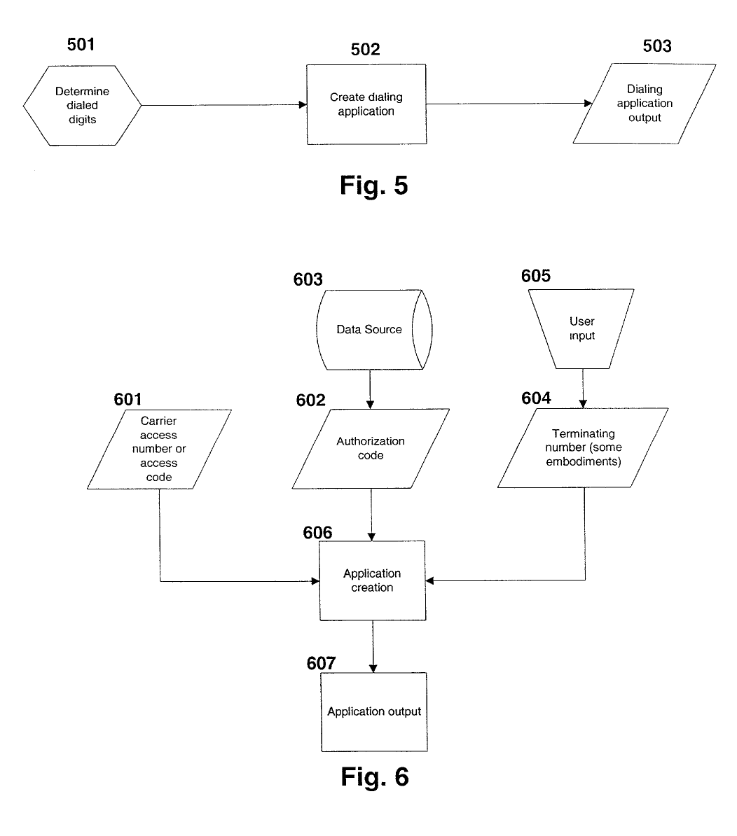

Turning to FIG. 5, illustrated is a simplified flowchart of how the present invention creates such a software application. At 501 the invention determines the digits that are to be dialed. Once the digits to be dialed are determined, these predetermined digits are used 502 to create the software application. Upon creation, the software outputs the application 503. In the preferred embodiment, the application thus created is advantageously portable and may be transmitted to target computer systems other than the one on which the application was created, where the application may then be used to make telephone charge card calls, analogous to the portability of a veridical telephone charge card.

Turning to FIG. 6, the determination of digits to be dialed 501 (FIG. 5) is treated in greater detail.

As illustrated, these digits include digits 601 for the carrier access number in the case of either form of carrier access number select, or for the carrier access code in the case of carrier code select. In the case of carrier code select dialing, this sequence of digits may also append the digit “0”.

Also included is the authorization code 602. As explained earlier, all forms of telephone charge card dialing specified herein require the use of a valid authorization code for call completion. This code, which will be recognized by the charge card carrier's equipment, is a sequence of digits that various embodiments of the invention may obtain from various data sources 603. In some embodiments, data source 603 is a database of valid codes belonging to the charge card carrier. In other embodiments, data source 603 is a database of valid codes that have been purchased from the charge card carrier by a third party creating the virtual telephone charge card. In yet other embodiments, as when a user is creating his or her own virtual telephone charge card, the authorization code may simply be some charge account belonging to the user, which will be the data source 603 in such embodiments. In any case, in preferred embodiments the authorization code is one that could be used for manual dialing and, as a rule, is obtained from the same sources 603 as are codes for manual dialing.

In addition to requiring access and authorization code digits, as provided in steps 601 and 602 respectively, the methods of charge card dialing described herein require terminating number digits for the call to be completed, as in 205 (FIG. 2), 303 (FIG. 3) and 401 (FIG. 4). A means, therefore, for obtaining the terminating number digits must be provided when the application executes to place a charge card call.

When the application is created for the purpose of connecting the caller to only one terminating number, it is created so that the digits to be dialed further include the terminating number 604. In some embodiments created for this purpose, the means for obtaining the terminating number digits comprises obtaining the digits 604 from input 605 from the user creating the virtual telephone charge card, as for the example described earlier of a parent creating a gift virtual telephone charge card application for a child. In other embodiments created for the purpose of connecting callers to only one terminating number, the means for obtaining digits 604 may comprise pre-programming the digits into the process creating the application, as when the invention is practiced to create applications that deliver calls to only one terminating number, for such purposes, for example, as delivery of promotional or other information to a caller from a particular destination number. In such a case, then, the input 605 for the terminating number comprises the process creating the application itself.

In the alternative, when the application is created to enable a caller to reach any terminating numbers entered by the caller, the terminating number digits will not be incorporated into the application upon creation. Rather the means of obtaining the terminating number digits for the execution of the application to place a charge card call comprises obtaining the terminating number digits from the caller as described in greater detail below.

In any case, using the access digits 601, authorization code digits 602 and, in some embodiments as described, terminating number digits 604, the virtual telephone charge card application may be created 606.

It should be noted that the forms of telephone charge card call dialing require pauses at intervals because of delays inherent in the equipment processing the call. For example, in CANS post-authorization code dialing (FIG. 2), there is a pause 202 between the dialing of the access digits 201 and the dialing of the authorization code 203. During this interval, the PSTN, having received the access digits for the charge card service provider's equipment, is connecting the caller to that equipment. After connection to the charge card service provider's equipment, there may be an additional pause required by a delay for prompt by the equipment for authorization code entry by the caller. At 204 there is an pause between dialing the access number 203 and dialing the terminating number 205.

Similarly, in CANS pre-authorization code dialing (FIG. 3), there is a pause 302 between dialing the access code 301 and dialing the terminating number 303, and another pause 304 between dialing the terminating number 303 and dialing the authorization code 305. In CCS dialing too (FIG. 4), a pause 402 is necessary between dialing the carrier access code plus 0 plus terminating number 401 and dialing the authorization code 403.

In some embodiments of the present invention, the virtual charge card application is created with some or all of the pauses 202, 204 or 302, 304 or 402, as the case may be, inherent in a pre-established dialing sequence in the application. For such embodiments, such pauses are treated as dialed digits in the step 501 (FIG. 5) of determining the dialed digits of the application as the application is created.

In other embodiments, some or all of the necessary pauses are determined as part of the dialing sequence only when the virtual charge card application is actually invoked by the user. Such pauses determined on invocation would not generally be treated as dialed digits determined 501 when the application is created.

In any case, returning to FIG. 6, when the telephone charge card application has been created 606, it is output 607, preferably in a portable form that may be transmitted between computer systems.

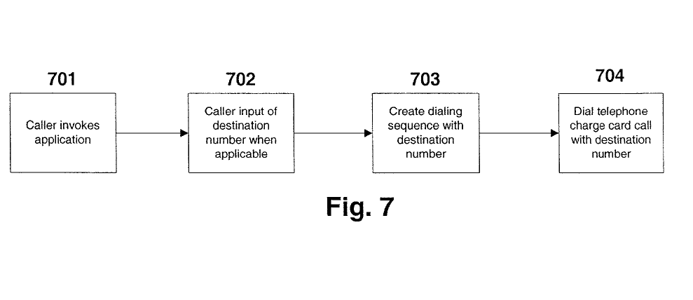

Turning now to FIG. 7, the invocation and execution of the application by a caller is illustrated. In 701, a caller invokes the virtual telephone charge card application. In a preferred embodiment, the charge card application is represented by a graphical icon in a graphical user interface (gui) environment. In that embodiment, the caller invokes the application in a conventional manner used for invoking or launching applications, such as, in the Microsoft Windows environment, performing a mouse double click on the icon as a shortcut on the caller's gui desktop.

Upon invocation, for applications where the means of obtaining the terminating number comprises obtaining the terminating number digits from the caller, the caller specifies the terminating number in 702 according to methods of prompting and obtaining user data entry input, as are extremely well developed in the computer programming arts.

In 703, the application creates the dialing sequence, which is the sequence of digits including pauses that must be dialed through the PSTN for the call to be processed and routed as described for FIGS. 2, 3 and 4. In 704, the application directs the caller's equipment to dial the resulting dialing sequence through the PSTN, completing the caller's telephone charge card call.

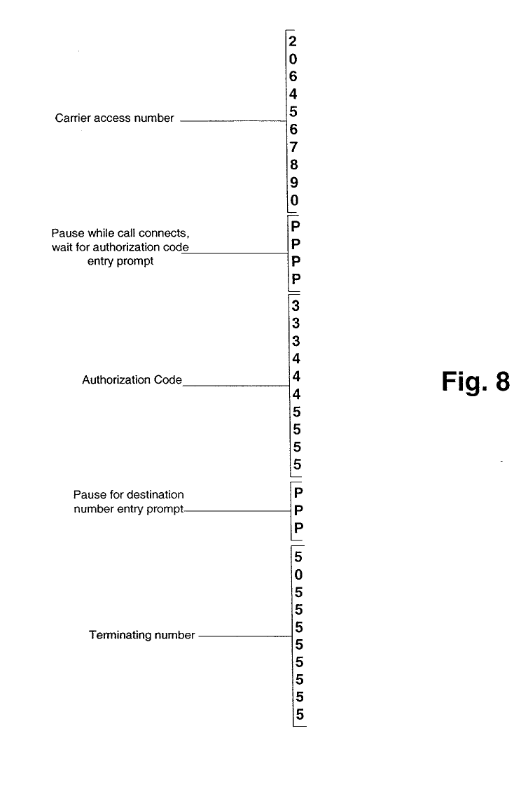

Examining the dialing sequence in more detail, presented in FIG. 8 is a representative dialing sequence as created by the present invention for CANS pre-authorization code dialing following the general pattern for such dialing as described herein above in relation to FIG. 2. The dialing sequence first comprises the fictitious access number (206) 456-7890, which, when dialed, will connect the caller to the charge card carrier's equipment.

Following the access number is a pause of a particular duration indicated by “PPPP”. The four “P”s indicate that, in this example, the duration of silence is equal to four inter-digit time intervals. As is well known to persons of skill in the art of telephone dialing and switching equipment, interdigit time intervals used by telephone equipment are typically on the order of 500 milliseconds in duration. In order to minimize call set-up time, it is standard practice in configuring automatic dialing equipment to adjust the interdigit interval to a duration approaching the lower limit of duration required for digit recognition by the particular telephone equipment in the PSTN serving the dialing equipment. In this example, four interdigit intervals are necessary, after the dialing of the access number, for the PSTN to switch the call to the charge card carrier's equipment and for that equipment to be prepared to accept dialed authorization code digits. Other CANS pre-authorization code dialing applications may require pauses of shorter or longer duration between the dialing of the access number and the dialing of the authorization code for such switching and preparation to complete.

Subsequent to such pause, the sequence comprises the authorization code 333-444-5555, a fictitious code used here for the purpose of illustration only. Following the authorization code is another pause, indicated here by “PPP” corresponding to three interdigit intervals. During this time, the charge card carrier's equipment, having received the authorization code, is validating the code and preparing to receive the digits for the terminating number. In this case, three interdigit intervals are necessary, but other applications may require pauses of shorter or longer duration after the authorization code for such validation and preparation to complete.

The final piece of the dialing sequence is the terminating number, in this case the fictitious number (505) 555-5555. As described earlier, in some embodiments this number has been entered as the desired call destination number by the caller, while in other embodiments this number is pre-programmed in the virtual charge card application.

As will be appreciated by those of ordinary skill in the art, other virtual telephone charge card applications may, as required, construct similar dialing sequences that are appropriate for the respective charge card service dialing patterns set forth in FIG. 3 and FIG. 4. In general, rules may be derived for other dialing patterns as required for the particular dialing location and the particular charge card and carrier employed. Given the dialing pattern, the charge card carrier's access digits, the authorization code and the terminating number, along with the necessary length of pause between dialing sequence steps, a rule-based means for generating an appropriate dialing sequence will simply follow the flow of the dialing pattern employed.

Next we turn to how the application directs the caller's equipment to dial the resulting dialing sequence through the PSTN, completing the caller's telephone charge card call.

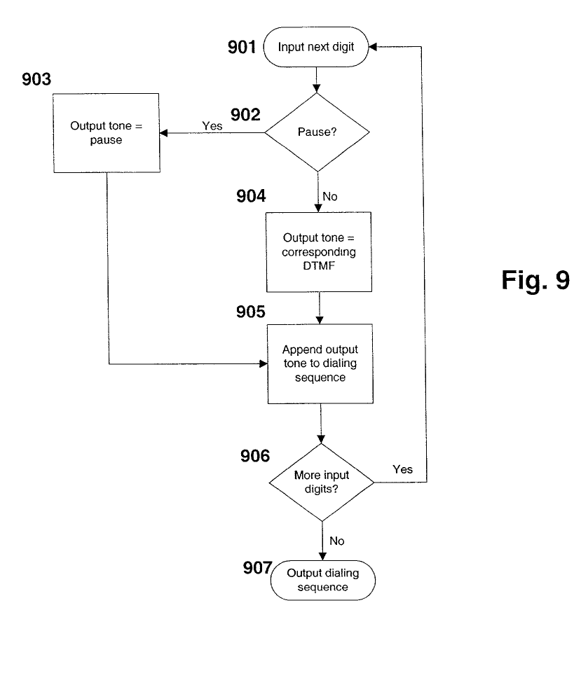

In one embodiment, the application simply creates an audio file containing digital representations of the tones necessary to dial the call: the tone sequence. The audio file may then be invoked to reproduce such tones which may then be used by the caller to complete the call, as will be explained in more detail below. Such an audio file might be a .wav file type in the Microsoft Windows environment or an .au file type in the Macintosh or Linux environment. In any case, FIG. 9 illustrates how the application in this embodiment creates such a file.

A tone sequence is simply a series of dual tone multiple frequency (DTMF) tones or silent pauses produced in succession. In a typical application, each tone or pause may be on the order of 200 milliseconds in duration. Typical interdigit timing (the time between the start of the dialing of one tone and the start of the dialing of a subsequent tone) is, as stated earlier, on the order of 500 milliseconds Silent pauses are part of the dialing sequence because they serve to delay transmission of additional tones until the charge card carrier's equipment is ready, as in 202, 204 (FIG. 2), 302, 304 (FIG. 3) and 402 (FIG. 4), as discussed earlier. Several pauses in succession may be necessary to result in a sufficiently long delay as necessitated for the particular dialing sequence. In an exemplary creation of a tone sequence from a dialing sequence, each digit in the dialing sequence is sequentially processed to create the tone sequence.

Turning to FIG. 9, beginning with an empty tone sequence and the first digit of the dialing sequence, digit input 901 from the dialing sequence is analyzed 902 to determine whether it is a pause. If it is a pause, the output tone is assigned 903 to be pause (i.e. silence). If it is not a pause (i.e. one of the digits 0-9), the DTMF tone corresponding to that digit is assigned 904 as the output tone. In either case, the assigned output tone is appended 905 to the tone sequence. If there are remaining digits to be processed in the dialing sequence 906, the process is repeated 901 and the next digit of the dialing sequence is analyzed, otherwise the tone sequence is complete and output 907.

As is well known by those of skill in the art, application programs are common that play an audio file, and in particular the audio file created by these embodiments of the virtual telephone charge card invention, through the sound system of the computer, producing audible renditions of the digitized audio file. By manually removing the handset of a telephone connected to the PSTN from its switch-hook and holding the microphone of the handset to the computer system speakers, thereafter playing the audio file produced according to such embodiments of the present invention, the caller causes appropriate tones to be sent through the PSTN to the charge card carrier's equipment at the appropriate times, resulting in proper switching and completion of the telephone charge card call for the caller.

In other embodiments, instead of simply creating an audio file of tones for playing through conventional telephone equipment, the application may direct dialing equipment within or in communication with the caller's computing equipment to dial the dialing sequence directly. As is well known to those of ordinary skill in the computer and telephony arts, a computer system may be directed to dial any sequence of digits through a modem with which it is in controlling communication by way of a modem driver. For example, in the Microsoft Windows environment, the Universal Modem Driver TSP (Unimodem) provides access to functions (including dialing) of nearly all standard modems. As is well known to those practicing in the art, Unimodem enables access to many telephony related software functionalities through Telephone Application Programming Interfaces (TAPIs). In the embodiments under consideration, the dialing sequence provided by the present invention is passed to Unimodem as a pointer to a null-terminated string containing an address comprising the sequence of digits to be dialed, and Unimodem is informed that the address represents a dialed number by setting an address type constant to indicate a standard telephone number:

LINEADDRESSTYPE_PHONENUMBER

0×00000001

Address type is a standard phone number.

Thus set, Unimodem uses the dialing sequence to drive the computing system modem to dial the corresponding tone sequence.

By utilizing such facilities as Unimodem within the computing system, these embodiments of the virtual telephone charge card application direct the system's modem to dial the digits necessary to place the telephone charge card call. Dialing in this manner, the caller then can use a telephone in communication with the modem equipment (as when, for example, connected to the PHONE port on the modem) to conduct and complete the call.

Although the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention. The invention is limited only by the following claims and their equivalents.

We claim:

1. A method of creating a portable virtual telephone charge card computer software application for a caller to place a telephone charge card call to a terminating number, comprising:
selecting digits for access to a telephone charge card carrier's equipment;
obtaining digits for a valid authorization code for a charge card account with the telephone charge card carrier; and
creating a sequence of operations that are operable, upon invocation by the caller, to request and obtain from the caller the terminating number digits for a telephone call, said sequence of operations further operable to use the access digits, the authorization code digits and the terminating number digits to create a dialing sequence, the dialing sequence comprising a sequence of digits and pauses which, when dialed, serve to place a telephone charge card call to the terminating number, the call charged to the charge card account.

2. A method of creating a portable virtual telephone charge card computer software application as in claim 1, wherein said creating step further comprises creating a sequence of operations that are operable, upon invocation by the caller, to dial the dialing sequence over the Public Shared Telephone Network.

3. A method of creating a portable virtual telephone charge card computer software application for a caller to place a telephone charge card call to a terminating number, comprising:
selecting digits for access to a telephone charge card carrier's equipment;
obtaining digits for a valid authorization code for a charge card account with the telephone charge card carrier;
obtaining the terminating number digits for a telephone call; and
creating a sequence of operations that are operable, upon invocation by the caller, to use the access digits, the authorization code digits and the terminating number digits to create a dialing sequence, the dialing sequence comprising a sequence of digits and pauses which, when dialed, serve to place a telephone charge card call to the terminating number, the call charged to the charge card account.

4. A method of creating a portable virtual telephone charge card computer software application as in claim 3, wherein said creating step further comprises creating a sequence of operations that are operable, upon invocation by the caller, to dial the dialing sequence over the Public Shared Telephone Network.

5. A virtual telephone charge card application for using a telephone charge card account in placing a telephone call to a terminating number, comprising:
means for obtaining terminating number digits; and
means, using the terminating number digits, for generating a dialing sequence, the dialing sequence comprising a sequence of digits and pauses which, when dialed, serve to place a telephone charge card call to the terminating number, the call charged to the telephone charge card account.

6. A method of placing a charge card telephone call to a destination telephone number using a virtual telephone charge card software application on a personal computer, comprising
invoking the virtual telephone charge card software application; and
responsive to a prompt from the application program, providing destination telephone number digits.
